(19) United States
(12) Patent Application Publication
(10) Pub. No.: US 2025/0132456 A1
(43) Pub. Date: Apr. 24, 2025

(54) BATTERY PACK WITH DOUBLE COVER

(71) Applicant: LG Energy Solution, Ltd., Seoul (KR)

(72) Inventors: Jung Hoon Lee, Daejeon (KR); Kwang Mo Kim, Daejeon (KR); Hye Mi Jung, Daejeon (KR)

(21) Appl. No.: 18/834,535

(22) PCT Filed: Jul. 20, 2023
(86) PCT No.: PCT/KR2023/010476

§ 371 Date: Jul. 30, 2024

(30) Foreign Application Priority Data
Dec. 15, 2022 (KR) 10-2022-0175851

(51) Int. Cl. H01M 50/367; H01M 50/271; H01M 50/289

(52) U.S. Cl. CPC H01M 50/367; H01M 50/271; H01M 50/289

(57) ABSTRACT

A battery pack with a double cover includes a plurality of battery modules; and a case accommodating the battery modules, the case includes the double cover disposed at an upper portion of the case, and the double cover includes a first lid disposed above the battery module and having a through hole; and a second lid above the first lid and spaced apart from the first lid.

### CROSS REFERENCE TO PRIOR APPLICATIONS

This application is a National Phase entry pursuant to 35 U.S.C. § 371 of International Application No. PCT/KR2023/010476, filed on Jul. 20, 2023, and claims the benefit of priority based on Korean Patent Application No. 10-2022-0175851 filed on Dec. 15, 2022, the disclosures of which are incorporated herein by reference in their entirety.

### TECHNICAL FIELD

The present disclosure relates to a battery pack, and more specifically, to a battery pack with a double cover that may prevent continuous ignition of modules inside the battery pack.

### BACKGROUND

Unlike primary batteries, which cannot be recharged, secondary batteries refer to batteries that may be charged and discharged, and they are applied not only to portable devices but also to electric vehicles (EVs) and hybrid vehicles (HEVs) that are driven by an electrical drive source.

Types of secondary batteries currently in wide use may include lithium ion batteries, lithium polymer batteries, nickel cadmium batteries, nickel hydrogen batteries, and nickel zinc batteries. An operating voltage of such a unit secondary battery cell, that is, a unit battery cell, is approximately 2.5V to 4.6V. Accordingly, when a higher output voltage is required, a battery pack is formed by connecting multiple battery cells in series. Additionally, a battery pack may be constructed by connecting multiple battery cells in parallel depending on the charge/discharge capacity required for the battery pack. Accordingly, the number of battery cells included in the battery pack may be set in various ways depending on the required output voltage or charge/discharge capacity.

When constructing a battery pack by connecting a plurality of battery cells in series/parallel, generally, a battery module consisting of at least one battery cell, preferably a plurality of battery cells, is first constructed, and a battery pack is constructed by using at least one such battery module and adding other components. Here, the battery module refers to a component in which multiple battery cells are connected in series or parallel, and the battery pack refers to a component in which multiple battery modules are connected in series or parallel to increase capacity, output and the like.

Typically, a vehicle battery pack includes a plurality of battery modules or battery module assemblies disposed on a same plane to maintain structural stability.

However, in such a battery pack, if there is overcharging, an explosion or fire may occur due to swelling of the battery module, and such explosion or fire may cause greater risk that may lead to casualties.

Accordingly, there is a need to find a way to provide a battery pack that may prevent additional ignition of adjacent battery modules when some battery modules in the battery pack ignite.

### SUMMARY

The present disclosure is directed to providing a battery pack that may prevent chain ignition of adjacent battery modules when some battery modules in the battery pack ignite.

According to the present disclosure, a battery pack with a double cover includes: a plurality of battery modules: and a case accommodating the battery modules, wherein the case includes the double cover disposed at an upper portion of the case, and the double cover includes: a first lid disposed above the battery module and having a through hole; and a second lid above the first lid and spaced apart from the first lid.

Furthermore, the battery pack with the double cover may further include a partition wall between the battery modules positioned on left and right sides in the case.

Furthermore, the partition wall may be disposed below the double cover.

Furthermore, the through hole of the first lid may be positioned above the partition wall. Furthermore, a heat dissipation hole may be formed in the second lid of the double cover.

Furthermore, the battery pack with the double cover may further include a flow path forming member protruding from a top of the partition wall in a direction of the through hole.

Furthermore, the flow path forming member may be disposed on left and right sides in a width direction of the partition wall, respectively.

Furthermore, when the battery module disposed on one side of the partition wall ignites, the flow path forming member may be bent in a direction of the battery module disposed on another opposite side of the partition wall due to heat from the ignition.

Furthermore, the flow path forming member may include a support leg that is supported on an upper surface of the partition wall when the flow path forming member is bent upon the ignition of the battery module.

Furthermore, the battery pack with the double cover may further include a heat dissipation guide between the first lid and the second lid, the heat dissipation guide being configured to guide heat dissipation.

Furthermore, the heat dissipation guide may be disposed on opposite sides with respect to the through hole.

Furthermore, the heat dissipation guide may be disposed on opposite edges of the through hole.

Furthermore, the heat dissipation guide may be openable and closable between the first lid and the second lid, and the heat dissipation guides may be open to dissipate heat when the battery module ignites.

Furthermore, the heat dissipation guide may include: a lower guide disposed on the first lid: and an upper guide disposed on the second lid.

Therefore, according to the present disclosure, a battery pack is provided that may prevent chain ignition of adjacent battery modules when some battery modules in the battery pack ignite.

### BRIEF DESCRIPTION OF THE DRAWINGS

FIG. 1 is a longitudinal cross-sectional view illustrating a battery pack with a double cover according to an embodiment of the present disclosure,

FIG. 2 is a perspective view illustrating a battery pack with a double cover according to an embodiment of the present disclosure,

FIG. 3 is a detailed view illustrating part A in FIG. 1,

FIG. 4 is a view illustrating a heat dissipation flow path when one battery module in FIG. 3 ignites, and

FIG. 5 is a longitudinal cross-sectional view illustrating a battery pack with a double cover according to another embodiment of the present disclosure.

### DETAILED DESCRIPTION

The advantages and features of the present disclosure and methods for achieving them will become clear by referring to the embodiments described in detail below along with the accompanying drawings. However, the present disclosure is not limited to the embodiments disclosed below and will be implemented in various different forms. The present embodiments only serve to ensure that the disclosure of the present disclosure is complete, it is provided to fully inform those who have common knowledge in the technical field to which the present disclosure pertains, and the present disclosure is only defined by the scope of the claims. Accordingly, in some embodiments, well-known process steps, well-known device structures, and well-known techniques are not specifically described in order to avoid ambiguous interpretation of the present disclosure. Like reference numerals refer to like elements throughout the specification.

In order to clearly express multiple layers and areas in the drawing, the thickness may be enlarged. Throughout the specification, similar parts are given the same reference numerals. When a part of a layer, film, region, plate, etc. is said to be “on” another part, this includes not only being “directly on” the other part, but also cases where there is another part in between. Conversely, when a part is said to be “directly on top” of another part, it means that there is no other part in between. Additionally, when a part of a layer, film, region, plate, etc. is said to be “beneath” another part, this includes not only cases where it is “directly below” another part, but also cases where there is another part in between. Conversely, when a part is said to be “directly below” another part, it means that there is no other part in between.

Spatially relative terms such as “below”, “beneath”, “lower”, “above”, “upper”, etc. are used to easily describe the correlation between one element or component and other elements or components as illustrated in the drawing. Spatially relative terms should be understood as terms that include different directions of the element during use or operation in addition to the direction illustrated in the drawings. For example, if an element illustrated in the drawings is turned over, an element described as “below” or “beneath” another element may be disposed “above” the other element. Accordingly, the illustrative term “down” may include both downward and upward directions. Elements may also be oriented in other directions, so spatially relative terms may be interpreted according to orientation.

Hereinafter, a battery pack with a double cover according to a preferred embodiment of the present disclosure will be described in detail with reference to the attached drawings.

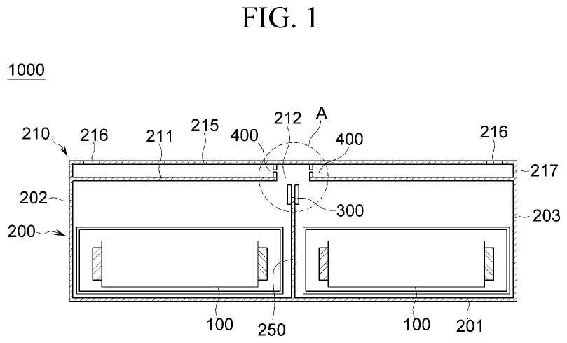

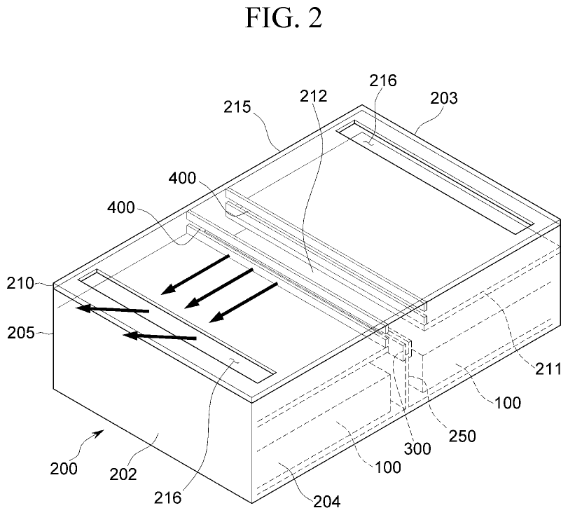

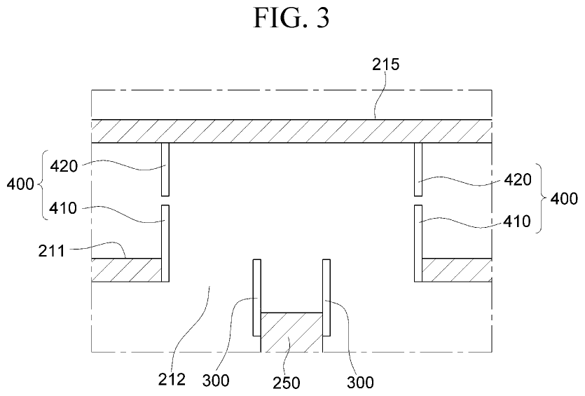

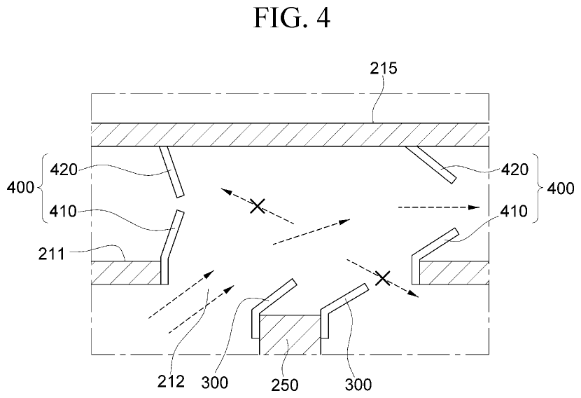

FIG. 1 is a longitudinal cross-sectional view illustrating a battery pack with a double cover according to an embodiment of the present disclosure, FIG. 2 is a perspective view illustrating a battery pack with a double cover according to an embodiment of the present disclosure, FIG. 3 is a detailed view illustrating part A in FIG. 1, and FIG. 4 is a view illustrating a heat dissipation flow path when one battery module in FIG. 3 ignites.

A battery pack 1000 with a double cover according to the present disclosure includes a plurality of battery modules 100, a case 200 for accommodating the plurality of battery modules 100; and a partition wall 250 in the case 200, and the case 200 includes a double cover 210.

The battery module 100 accommodated in the battery pack 1000 includes a plurality of battery cells (not illustrated), and each battery cell may be, for example, a pouch-type battery cell.

As an example, the battery module 100 may include a plurality of battery cells stacked on each other, and each battery cell may be provided with electrode leads at front and rear ends, respectively, with an anode lead at the front end and a cathode lead at the rear end. The plurality of battery cells in the battery module 100 may be stacked to be electrically connected to each other.

The battery cells are not limited to pouch-type battery cells and may be made into other types of battery cells such as prismatic battery cells, and the plurality of battery cells may be accommodated in the case of the battery module 100.

The case 200 is for accommodating the plurality of battery modules 100 and includes a bottom 201, a left side 202, a right side 203, a front side 204, and a rear side 205, and a cover covering the case 200 is disposed at an upper portion of the case 200.

The bottom 201 of the case 200 is in the form of a plate extending in the horizontal direction and forms a bottom of the case 200.

In the case 200, the left side 200 and the right side 203 form left and right side surfaces of the case 200, respectively, and the left side 202 and the right side 203 are disposed on the left and right edges of the bottom 201, respectively.

In the case 200, the front side 204 and the rear side 205 form front and rear surfaces of the case 200, respectively, and the front side 204 and the rear side 205 are disposed at front and rear edges of the bottom 201, respectively.

As such, the left side 202, the right side 203, the front side 204, and the rear side 205 of the case 200 form side surfaces of the case 200.

In the present embodiment, the case 200 is illustrated in the form of a quadrangular box as illustrated, but it is not limited to this and may be configured in various shapes, including polygons.

Additionally, a partition wall 250 is disposed at a center of the case 200.

The partition wall 250 which partitions a space for accommodating the battery module 100 disposed on the left side and the battery module 100 disposed on the right side in the case 200 is disposed perpendicularly to the bottom 201 of the case 200, and one end and another end of the partition wall 250 may be disposed in contact with the front side 204 and the rear side 205, respectively.

As illustrated in FIG. 1, the battery module 100 may be accommodated on the left and right sides with respect to the partition wall 250, and a height of the partition wall 250 from the bottom 201 of the case 200 may be configured to be equal to or lower than that that of the first lid 211.

FIG. 1 is a longitudinal cross-sectional view illustrating the battery pack 1000 according to the present embodiment, in which a left battery module 100 and a right battery module 100 are disposed with respect to the partition wall 250 inside the case 200.

Meanwhile, in another embodiment, unlike in FIG. 1, two or more partition walls 250 may be disposed in the left and right direction, and in FIG. 2, two or more battery modules 100 may be disposed in the front and rear direction. When two or more battery modules 100 are disposed from the front side 204 to the rear side 205, a separation wall may be disposed between the battery modules 100. The separation wall may extend from the left side 202 to the right side 203, and a top of the separation wall may extend to a bottom of the first lid 211.

A cover that covers the inside of the case 200 is disposed at an upper portion of the case 200. In the present disclosure, the cover of the case 200 is configured as a double cover 210. The cover may be coupled to a body of the case 200, or may be formed integrally with the body of the case 200. When the cover is coupled to the body of the case 200, it may be coupled with bolts to a top of each of the left side, right side, the front side, and the rear side of the case 200, respectively.

In the present disclosure, the double cover 210 constituting the cover of the case 200 includes a first lid 211, a second lid 215, and a side wall 217.

The first lid 211 is disposed above the battery module 100 and the partition wall 250, and edges of the first lid 211 may be disposed on the left side 202, the right side 203, the front side 205 and the rear side 205 of the case 200, respectively. The first lid 211 may be disposed upwardly apart from the partition wall 250 by a certain distance.

A through hole 212 is formed in the first lid 211 above of the partition wall 250.

In the present embodiment, the through hole 212 of the first lid 211 may be disposed at a center of the first lid 211 as illustrated in FIG. 1, and as illustrated, the through hole 212 of the first lid 211 may be disposed to overlap the partition wall 250 in a plan view. Specifically, in the present embodiment, the partition wall 250 may be disposed at the center of the through hole 212 in a plan view, and a left and right width of the through hole 212 may be larger than a width of the partition wall 250.

As illustrated in FIG. 2, the through hole 212 of the first lid 211 is formed to extend along a longitudinal direction of the partition wall 250, and a length of the through hole 212 along a longitudinal direction of the partition wall 250 may be equal to or smaller than that of the partition wall 250.

A heat dissipation guide 400 is disposed on opposite edges of the through hole 212, respectively, with respect to the partition wall 250.

The side wall 217 constitutes a side surface of the double cover 210, and is disposed along an edge of the first lid 211, and the second lid 215 is disposed at a top of the side wall 217.

The second lid 215 is disposed upwardly apart from the first lid 211 and disposed at a top of the side wall 217, and an edge of the second lid 215 may be disposed at the top of the side wall 217.

Heat dissipation holes 216 are formed at opposite edges of the second lid 215. The heat dissipation hole 216 is for discharging heat emitted from an ignited battery module 100 when one of the battery modules 100 ignites, and as illustrated in FIG. 2, the heat dissipation hole 216 located on a left side of the second lid 215 extends along a left side end of the second lid 215, and the heat dissipation hole 216 disposed on a right side of the second lid 215 extends along a right side end of the second lid 215.

Accordingly, in the present disclosure, heat generated from the ignited battery module 100 flows into the space between the first lid 211 and the second lid 215 in a diagonal direction through the through hole 212 in the form of gas or thermal energy and is then discharged through heat dissipation hole 216 on one side. As such, in the present disclosure, since the cover of the case 200 is configured as the double cover 210, and the double cover 210 serves as a heat energy discharge passage, heat energy generated from ignition may be discharged to the outside, rapid inflow of oxygen from the outside may be prevented, and sparks or flames may be prevented, thereby preventing continuous ignition.

In the present disclosure, a flow path forming member 300 is disposed on the partition wall 250. As illustrated, the flow path forming member 300 is disposed to protrude from a top of the partition wall 250 in a direction of the through hole 212, and is disposed on left and right sides in a width direction (thickness direction) of the partition wall 250.

As illustrated in FIG. 3, the flow path forming member 300 disposed on opposite sides of the partition wall 250 may be formed including a lower portion coupled to the partition wall 250 and an upper portion protruding from the top of the partition wall 250 in the direction of the through hole 212.

The lower portion of the flow path forming member 300 may be coupled to an upper portion of one side of the partition wall 250 as illustrated, and may be fastened to the partition wall 250 with bolts, for example.

The upper portion of the flow path forming member 300 protrudes from the partition wall 250 so that a top of the upper portion may be located at a same level as or lower than the first lid 211 with respect to the bottom 201.

FIG. 4 is a diagram illustrating movement of heat in the present disclosure when the battery module 100 disposed on a left side of the partition wall 250 ignites, where when the battery module 100 disposed on the left side of the partition wall 250 ignites, due to heat generated therefrom, the flow path forming member 300 is bent toward the battery module 100 on an opposite right side, thereby blocking inflow of heat energy into the right battery module 100. Furthermore, this causes heat (thermal energy or gas form) to move in a diagonal direction and guides the movement of heat into a space between the first lid 211 and the second lid 215 above the right battery module 100.

Similarly, although not illustrated, when the battery module 100 disposed on the right side of the partition wall 250 ignites, due to heat generated therefrom, the flow path forming member 300 is bent toward the left battery module 100, thereby blocking inflow of heat energy into the left battery module 100, and guiding heat (thermal energy or gas form) to move upward to the left into a space between the first lid 211 and the second lid 215 located above the left battery module 100.

A material of the flow path forming member 300 may include, for example, aluminum, stainless steel (SUS), and the like, and a thickness may be less than 1 mm, but it is not limited thereto, and a configuration in which the flow path forming member 300 is flexible to bend due to the heat generated toward the opposite battery module 100 may be used.

Additionally, in the present disclosure, a heat dissipation guide 400 is disposed on the double cover 210. The heat dissipation guide 400 is disposed between the first lid 211 and the second lid 215 in the double cover 210 to guide heat discharge when the battery module 100 ignites, and the heat dissipation guide 400 is disposed to be openable and closable between the first lid 211 and the second lid 215 to control heat discharge. Here, closing of the heat dissipation guide 400 means not only completely closing a space between the first lid 211 and the second lid 215, but also minimizing the space for heat flow between the first lid 211 and the second lid 215. Similarly, opening of the heat dissipation guide 400 means not only fully opening but also increasing the space for heat flow between the first lid 211 and the second lid 215 relative to the closed state.

In the present disclosure, the heat dissipation guide 400 is disposed opposite to each other on opposite sides with respect to the through hole 212 between the first lid 211 and the second lid 215 as illustrated in FIGS. 3 and 4, and each heat dissipation guide 400 includes a lower guide 410 and an upper guide 420.

The lower guide 410 is disposed on the first lid 211 and extends by protruding from the first lid 211 in a direction of the second lid 215. A height of the lower guide 410 protruding from the first lid 211 may be equal to or less than half a distance between the first lid 211 and the second lid 215 and may be formed to have a length equal to a length of the first lid 211 in a direction from the front side 204 to the rear side 205. FIGS. 3 and 4 illustrate an example in which the lower guide 410 is disposed at an edge of the through hole 212, and the lower guide 410 may be coupled to an inner peripheral surface of the through hole 212 with a bolt.

The upper guide 420 on the second lid 215 protrudes and extends in a direction of the first lid 211 to face the lower guide 410 and is disposed directly above the lower guide 410. In the present embodiment, the upper guide 420 may be coupled to the second lid 215 with a bolt. A height of the upper guide 420 protruding from the second lid 215 may be equal to or less than half the distance between the first lid 211 and the second lid 215 and may be formed to have a length equal to a length of the second lid 215 in the direction from the front side 204 to the rear side 205.

In a state that the space between the first lid 211 and the second lid 215 is closed as illustrated in FIG. 3, when the battery module 100 ignites, the upper and lower guides 420 and 410 are deformed by the heat as illustrated in FIG. 4 to be bent toward an end portion of the second lid 215 where the heat dissipation hole 216 is formed, thereby opening the space between the first lid 211 and the second lid 215 to guide heat dissipation.

In the present embodiment, the heat dissipation guide 400 is described as including the upper and lower guides 420 and 410, but as another example, it may be composed of the upper guide 420 or the lower guide 410.

A material of the heat dissipation guide 400 may include, for example, aluminum or stainless steel (SUS), and a thickness may be less than 1 mm, but it is not limited thereto.

In a normal state, in the battery pack 1000 with the double cover according to the present disclosure having the above-described configuration, the flow path forming member 300 which is disposed above the partition wall 250 maintains a vertical state and the heat dissipation guide 400 disposed between the first lid 211 and the second lid 215 maintains a closed state, as illustrated in FIG. 3.

In this state, when the battery module 100 on one side of the partition wall 250 ignites as illustrated in FIG. 4, the heat generated from the ignited battery module 100 flows toward the through hole 212.

At this time, the flow path forming member 300 disposed above the partition wall 250 is deformed and bent toward the opposite battery module 100 due to the heat flowing into the space between the through hole 212 and the partition wall 250.

Accordingly, the flow path forming member 300 blocks the inflow of heat energy into the opposite battery module 100, and guides heat (thermal energy or gas form) to move in a diagonal direction toward the space between the first lid 211 and the second lid 215 above the opposite battery module 100.

The heat passing through the flow path forming member 300 moves in a diagonal direction as illustrated in FIG. 4 and moves between the first lid 211 and the second lid 215 above the opposite battery module 100.

Then, the heat dissipation guide 400 between the first lid 211 and the second lid 215 above the opposite battery module 100 (right side of the through hole 212 in FIG. 4) is deformed by heat as illustrated in FIG. 4 to be in an open state, and accordingly, heat moves to the space between the first lid 211 and the second lid 215 and is then discharged through the heat dissipation hole 216. At this time, the heat dissipation guide 400 between the first lid 211 and the second lid 215 above the ignited battery module 100 (left side of the through hole 212 in FIG. 4) is in a closed state, thereby preventing the explosive inflow of oxygen from the outside and preventing the discharge of sparks generated internally.

As such, in the present disclosure, when the battery module 100 disposed on one side of the partition wall 250 ignites, the flow path forming member 300 blocks heat from flowing into the adjacent battery module 100, thereby preventing chain explosion of the battery module 100, a heat energy discharge path is formed through the double cover 210, and explosive oxygen inflow from the outside and discharge of sparks generated inside are prevented.

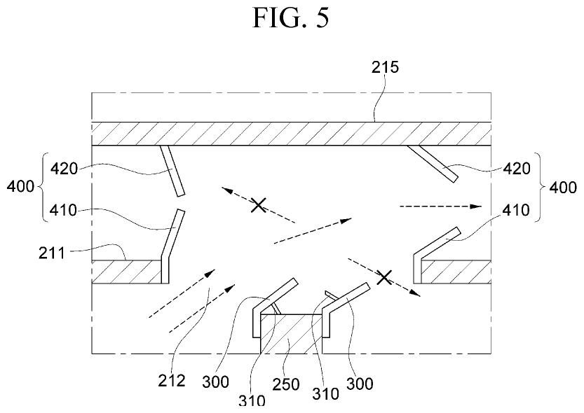

FIG. 5 illustrates a battery pack with a double cover according to a second embodiment of the present disclosure, where a difference of the second embodiment from the first embodiment is that the flow path forming member 300 has a support leg 310.

The support leg 310 is disposed on one side of the flow path forming member 300 disposed on opposite sides of the partition wall 250 to support the flow path forming member 300, and as illustrated in FIG. 5, when the flow path forming member 300 is bent toward the opposite right battery module 100 as illustrated by the heat generated due to ignition of the battery module 100, the support leg 310 is supported on an upper surface of the partition wall 250.

If the flow path forming member 300 is excessively bent toward the opposite battery module 100, it will not be able to block heat from flowing toward the opposite battery module 100, but in the present embodiment, the support leg 310 is supported by the upper surface of the partition wall 250, and excessive deformation of the flow path forming member 300 is prevented, thereby preventing the problem of not being able to block heat from flowing into the opposite battery module 100.

The support legs 310 may be formed to have a length equal to a length of the flow path forming member 300 in a longitudinal direction of the partition wall 250, and a plurality of support legs 310 may be formed along the longitudinal direction of the partition wall 250 while being spaced apart from each other.

In another embodiment, a support (not illustrated), instead of the support leg 310, may be provided on the upper surface of the partition wall 250 to support the flow path forming member 300 when the flow path forming member 300 is bent toward the opposite right battery module 100. The support may be disposed on the upper surface of the partition wall 250 to prevent the flow path forming member 300 from being excessively deformed.

Although the present disclosure has been described with reference to preferred embodiments as discussed above, it is not limited to the above-described embodiments, and changes and modifications in various ways may be made by those skilled in the art without departing from the spirit of the disclosure.

### INDUSTRIAL APPLICABILITY

The present disclosure provides a battery pack that may prevent chain ignition of adjacent battery modules when some battery modules in the battery pack ignite.

1. A battery pack with a double cover, the battery pack comprising:
a plurality of battery modules; and
a case accommodating the battery modules,
wherein the case comprises the double cover disposed at an upper portion of the case, and the double cover comprises:
a first lid disposed above the battery module and having a through hole; and
a second lid above the first lid and spaced apart from the first lid.

2. The battery pack with the double cover of claim 1, further comprising a partition wall between the battery modules positioned on left and right sides in the case.

3. The battery pack with the double cover of claim 2, wherein the partition wall is disposed below the double cover.

4. The battery pack with the double cover of claim 3, wherein the through hole of the first lid is positioned above the partition wall.

5. The battery pack with the double cover of claim 3, wherein a heat dissipation hole is formed in the second lid of the double cover.

6. The battery pack with the double cover of claim 4, further comprising a flow path forming member protruding from a top of the partition wall in a direction of the through hole.

7. The battery pack with the double cover of claim 6, wherein the flow path forming member is disposed on left and right sides in a width direction of the partition wall, respectively.

8. The battery pack with the double cover of claim 6, wherein when the battery module disposed on one side of the partition wall ignites, the flow path forming member is bent in a direction of the battery module disposed on another opposite side of the partition wall due to heat from the ignition.

9. The battery pack with the double cover of claim 8, wherein the flow path forming member comprises a support leg that is supported on an upper surface of the partition wall when the flow path forming member is bent upon the ignition of the battery module.

10. The battery pack with the double cover of claim 1, further comprising a heat dissipation guide between the first lid and the second lid, the heat dissipation guides being configured to guide heat dissipation.

11. The battery pack with the double cover of claim 10, wherein the heat dissipation guide is disposed on opposite sides with respect to the through hole, respectively.

12. The battery pack with the double cover of claim 11, wherein the heat dissipation guide is disposed on opposite edges of the through hole, respectively.

13. The battery pack with the double cover of claim 10, wherein the heat dissipation guide is openable and closable between the first lid and the second lid, and
the heat dissipation guide is open to dissipate heat when the battery module ignites.

14. The battery pack with the double cover of claim 13, wherein the heat dissipation guide comprises:
a lower guide disposed on the first lid; and
an upper guide disposed on the second lid.

15. The battery pack with the double cover of claim 5, further comprising a heat dissipation guide between the first lid and the second lid, the heat dissipation guides being configured to guide heat dissipation.
